(19) United States
(12) Patent Application Publication
(10) Pub. No.: US 2015/0259178 A1
(43) Pub. Date: Sep. 17, 2015

(54) Cleaning Pad and Cleaning Implement

(71) Applicant: RENAELC, INC., Houston, TX (US)

(72) Inventors: ORI ROSENBAUM, WOODLAND HILLS, CA (US); ANDREW FURIA, APPLE VALLEY, CA (US)

(73) Assignee: RENAELC, INC., Houston, TX (US)

(21) Appl. No.: 14/206,215

(22) Filed: Mar. 12, 2014

(51) Int. Cl. B66B 31/00; B08B 1/00

(52) U.S. Cl. CPC B66B 31/003; B08B 1/006

(57) ABSTRACT

The present invention relates to a cleaning pad, cleaning device, and a method for cleaning. The cleaning pad has a plurality of ridges and grooves configured to mesh with the channels and ribs of an escalator or moving walkway step. The cleaning device includes a head portion configured to attach to a handle, and a cleaning pad removably attached to the head portion.

### TECHNICAL FIELD

The present disclosure relates in general to devices and processes for the separation and/or removal of dirt, scale, tarnish, impurities or any other foreign or undesired matter from solid materials or objects, more particularly to devices and processes for cleaning an escalator or moving walkway.

### BACKGROUND ART

Escalators and moving walkways are used around the world to transport pedestrians between floors of a building or along stretches of moving walkways (e.g., shopping centers, airports, transit systems, trade centers, hotels, public buildings, and so forth). Generally, escalators and moving walkways are constructed with a series of steps linked by a continuous chain so that they form a moving staircase or moving walkway.

Typically, the upper surface of the step is provided with a series of parallel tread ribs separated by tread channels. The channels and ribs tend to accumulate dirt and debris from the movement of traffic on the escalators. To maintain the aesthetics and sanitary conditions of the escalator or moving walkway, the steps need to be periodically cleaned. The channels are often narrow and deep, and the bottoms of the channels typically have square or sharp corners, which makes the surfaces of the steps more difficult to clean than other surfaces such as smooth flooring.

Traditional escalator or moving walkway cleaning techniques require the apparatus to be entirely dismantled and each step cleaned manually, which can be very time consuming and labor intensive. The escalator or moving walkway also has to be shut down during the cleaning process. Some of the buildings, particularly those that stay open 24 hours a day, require that the cleaning be done in the shortest period of time, preferably not requiring hours-long shutdowns.

An alternative is to use a conventional vacuum cleaner or other vacuum device to try to retrieve as much loose dust and accumulated debris from the channels and ribs as possible. U.S. Pat. No. 8,337,625, which is hereby incorporated by reference in its entirety, discloses, inter alia, a vacuum cleaner for an escalator step. However, such a device can be ineffective because the brush of a conventional vacuum cleaner may not reach deep enough into the channel to dislodge accumulated dirt and stubborn debris such as chewing gum, stains from spilled drinks, oil or grease buildup from the mechanics of the machinery beneath the step, and so forth.

Therefore, a need exists for a device and/or process for efficiently cleaning the steps of an escalator or moving walkway, preferably a device or process that thoroughly cleans the channels and ribs of the step and also dislodges the accumulated dirt, without marring the finish of the step.

### SUMMARY OF INVENTION

The purpose of the invention is to accomplish at least one of the following objects. An object of this invention is to provide a device and process for cleaning the steps of an escalator or moving walkway. A further object of this invention is to provide a device and process that cleans and dislodges accumulated dirt in the channels and ribs of the step, particularly the bottoms and sides of the channels. Additional objects and advantages of this invention shall become apparent from the ensuing descriptions of the invention.

According to a first aspect of the invention, a cleaning pad for an escalator or moving walkway is provided. The cleaning pad includes a contact surface with a plurality of ridges and grooves configured to mesh with the ribs and channels of an escalator or moving walkway step.

According to a second aspect of the invention, a device for cleaning an escalator or moving walkway is provided. The device includes a head portion configured to attach to a handle, and a cleaning pad removably attached to the head portion. The cleaning pad includes a contact surface with a plurality of ridges and grooves configured to mesh with the ribs and channels of an escalator or moving walkway step.

According to a third aspect of the invention, a method for cleaning an escalator or moving walkway is provided. The method comprises mounting a cleaning pad to a cleaning implement, loading the contact surface with cleaning fluid, placing the contact surface on a step of the escalator or moving walkway, and aligning and meshing the ridges and grooves of the cleaning pad with the step.

The foregoing brief summary of the invention presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented below.

Additionally, the foregoing has outlined rather broadly the features and technical advantages of the present invention in order that the detailed description of the invention that follows may be understood. Additional features and advantages of the invention will be described hereinafter, which form the subject of the claims of the invention. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features, which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF DRAWINGS

The accompanying drawings illustrate various embodiments of this invention. However, it is to be understood that these embodiments are not intended to be exhaustive, nor limiting of the invention. These embodiments are but examples of some of the forms in which the invention may be practiced.

FIG. 1 is a perspective view of a cleaning pad according to this invention.

FIG. 2 is a view of a cleaning pad being attached to a cleaning implement.

FIG. 3 is a view of a cover being removed from a cleaning pad and a close-up view of the cleaning pad grooves and ridges.

FIG. 4A is a bottom view of a cleaning implement according to this invention.

FIG. 4B is a bottom view of a cleaning pad attached to a cleaning implement.

FIG. 4C is a side view of a cleaning pad attached to a cleaning implement in use with an escalator or walkway.

FIG. 4D is a close-up view of the ridges and grooves of the cleaning pad meshing with the channels and ribs of the tread surface of an escalator or walkway step during cleaning operations.

FIG. 5 is a view of a cleaning device and a cleaning trough with cleaning fluid.

FIG. 6 is a view of a cleaning pad being loaded with cleaning fluid.

FIG. 7 is a view of a cleaning implement with a cleaning pad attached in use with an escalator or moving walkway.

FIG. 8 is a view of a cleaning pad cleaning an escalator or walkway step.

FIG. 9 is another view of a cleaning pad cleaning an escalator or walkway step.

FIG. 10 is a view of the removal and disposal of a cleaning pad.

FIG. 11 is a view of a cleaning pad produced by a die-cutting process according to this invention.

### DESCRIPTION OF EMBODIMENTS

Without any intent to limit the scope of this invention, reference is made to the figures in describing the preferred embodiments of the invention.

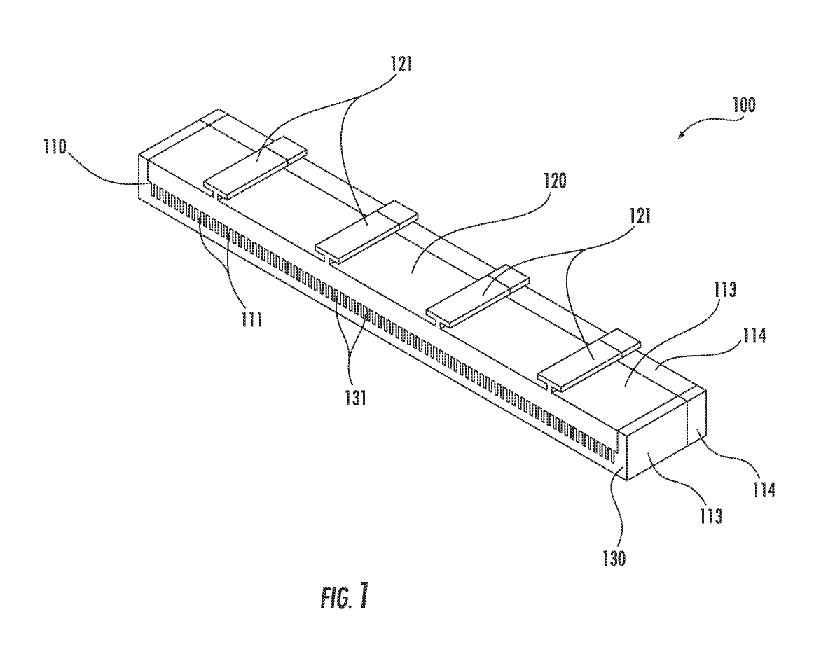

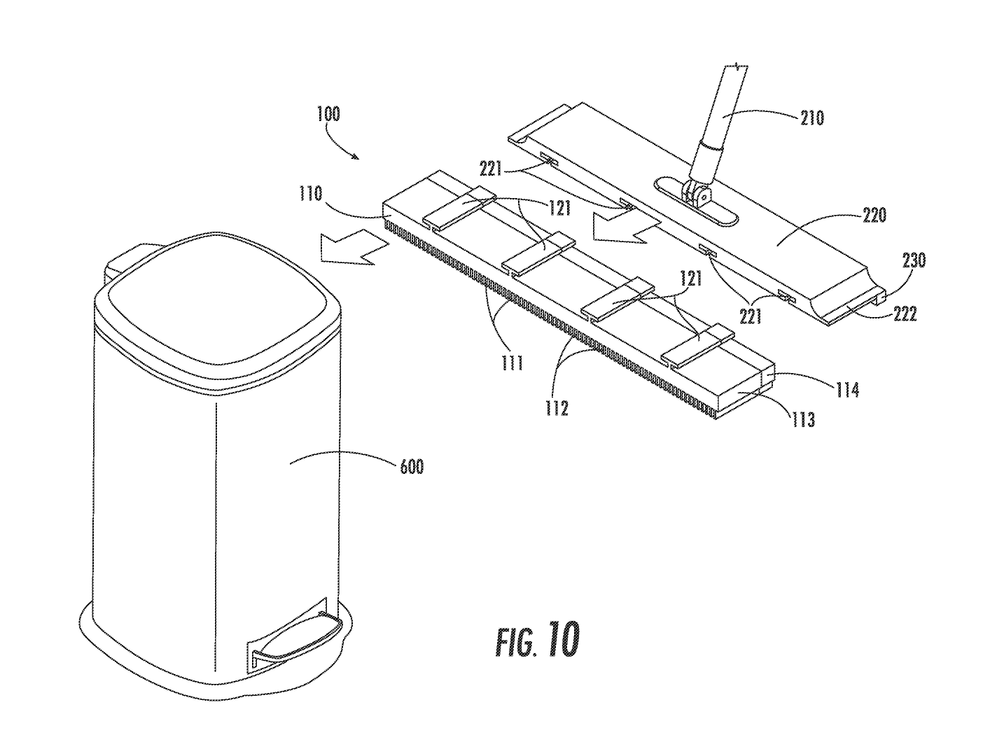

FIGS. 1-11 depict a cleaning pad 100 for use in the present invention. The cleaning pad 100 comprises a contact surface 110 configured to capture and retain cleaning fluid, dirt and/or soil that is absorbed, dislodged, picked-up other otherwise carried away by the cleaning pad 100 during use. The contact surface 110 has a plurality of ridges 111 and grooves 112 configured to mesh with the channels 403 and ribs 402 of an escalator or moving walkway step 401. The width W_{pad} of the cleaning pad 100 generally corresponds to the width of the step 401. As depicted in FIG. 9, although the cleaning pad 100 can be constructed from materials that are sufficiently soft and pliable to permit the pad to fit between the sides of an escalator or moving walkway 400 even with minimal or no clearance, the cleaning pad 100 preferably has a width W_{pad} that is slightly less (e.g., at least about 0.0625 inches) than the distance between the sides of the escalator or walkway 400. This configuration will help to ensure that the cleaning pad 100 is sized to substantially contact the majority of the tread surface 406 of the step 401, preferably most or all of the step, while not being too large to prevent the cleaning pad from fitting on the step 401. Preferably, the cleaning pad 100 has width W_{pad} of about 24 inches to 39 inches, a height H_{pad} of about 0.5 to 3 inches, and a length L_{pad} of about 2 to 12 inches, more preferably a length L_{pad} of about 2 to 6 inches.

The cleaning pad 100 further comprises an absorbent material 113. The absorbent material 113 comprises any material capable of absorbing and retaining cleaning fluid during use. The absorbent material 113 should be capable of absorbing and retaining enough cleaning fluid to cover the entire tread surface 406 of the step 401 during cleaning while also not releasing too much cleaning fluid too quickly, which can create pockets or puddles of cleaning fluid that can damage the escalator or moving walkway 400. Absorbent material 113 possessing the following properties provide a cleaning pad 100 having excellent cleaning fluid absorption and retention properties as well as the ability to release the cleaning fluid evenly and consistently to the step 401 during use. The pore size of the absorbent material 113 is preferably about 20 to 150 pores per inch (PPI), more preferably about 50 to 100 PPI. The air flow of the absorbent material 113 is preferably about 1.0 to 10.0 cubic feet per minute (CFM), more preferably about 2.0 to 7.0 CFM. The density or compression force deflection (CFD) of the absorbent material 113 is preferably about 0.80 to 5.0 pounds per cubic foot (lbₘ/ft³), more preferably about 0.80 to 3.0 lbₘ/ft³. The indentation force deflection (IFD) of the absorbent material 113 is preferably about 15 to 150 lb_{f}, more preferably about 50 to 150 lb_{f}. The indentation load deflection (ILD) of the absorbent material 113 is preferably about 10 to 140 lb_{f}, more preferably about 30 to 140 lb_{f}. The wet-out, which is the time for 2 cubic centimeters of water placed on top of the absorbent material completely penetrate it, is preferably about 0.5 to 5 minutes, more preferably less than about 2 minutes. Air flow, density, IFD, and ILD values can be measured as disclosed in ASTM International Standard D3574, which is hereby incorporated by reference in its entirety.

Suitable absorbent material 113 can include hydrophilic materials such as open cell polyurethane, paper/pulp molded combinations, flexible foams, particularly foams fabricated through a double cell design or a reticulated design, and so forth. The term “hydrophilic” refers to surfaces that are wettable by aqueous cleaning fluids deposited thereon. Hydrophilicity and wettability are typically defined by the geometry of the water on a flat surface—specifically, the contact angle which is the angle between a droplet's edge and the surface underneath. A surface is considered to be wetted by a cleaning fluid (i.e., hydrophilic) when either the contact angle between the cleaning fluid and the surface is less than about 90°, or when the cleaning fluid tends to spread spontaneously across the surface, both conditions normally co-existing. Conversely, a surface is considered to be “hydrophobic” (i.e., surfaces that are not wettable by aqueous cleaning fluids deposited thereon) if the contact angle is greater than about 90° and the cleaning fluid does not spread spontaneously across the surface.

The cleaning pad 100 can further comprise a semi-rigid material 114. The semi-rigid material 114 provides desired rigidity to the cleaning pad 100. The semi-rigid material 114 comprises any material sufficiently rigid to assist aligning the ridges 111 and grooves 112 of the absorbent material 113 with the channels 403 and ribs 402 and of the tread surface 406 of the step 401. The semi-rigid material 114 can assist with aligning by preventing the less rigid absorbent material 113 from creeping into the comb 404, which can create potential hazards and damage due to jamming or grabbing between the absorbent material 113 and comb 404. In one embodiment, the rigidity of the semi-rigid material 114 is greater than that of the absorbent material 113. The semi-rigid material 114 can be attached substantially parallel to the absorbent material 113, as shown in FIG. 1, preferably along the width W_{pad} of the cleaning pad 100 so that the ridges 111 and grooves 112 of the semi-rigid material 114 are coincident with those of the absorbent material 113. This arrangement helps maintain the structural integrity of the cleaning pad 100 and contact between the top 115 and sides 116 of the cleaning pad ridges 111 and the bottom 407 and sides 408 of the channels 403 of the step 401. Additionally, in this arrangement, the ridges 111 and grooves 112 of semi-rigid material 114 align with the channels 403 and ribs 402 of the tread surface 406 of the step 401 to act as a wiper or squeegee thereby preventing excess liquid from forming on the step, which can potentially damage the escalator or moving walkway 400. The semi-rigid material 114 also helps redistribute the cleaning fluid 301 released from the absorbent material 113 over the entire expanse of the tread surface 406 of the step 401. The semi-rigid material 114 can also provide more force to remove stubborn dirt and debris (e.g. gum) from the tread surface 406 of the step 401. Suitable examples of semi-rigid material 114 include, but are not limited to, hydrophobic materials such as thermoplastics (e.g. polyethylene, rubber, etc.), corks, and so forth.

As shown in the Figures, the ridges 111 and grooves 112 of the contact surface can be constructed from the absorbent material 113 and the semi-rigid material 114. In one embodiment, the majority of the ridges 111 and grooves 112 are constructed from the absorbent material 113, which permits the cleaning pad to absorb and retain enough cleaning fluid 301 to clean the tread surface 406 of the step 401. As discussed above, an adequate amount of the ridges 111 and grooves 112 are constructed from the semi-rigid material 114 to prevent excess liquid from forming on the step and to help redistribute cleaning fluid 301 released from the absorbent material 113 over the entire expanse of the tread surface 406 of the step 401. In an embodiment, the ridges 111 and grooves 112 are constructed from about 10% to 25% semi-rigid material 114 and about 75% to 90% absorbent material 113 to ensure enough cleaning fluid 301 is absorbed, retained and delivered to the cleaning step while also preventing, inter alia, excess liquid from forming on the step. In another embodiment, it may be desired to construct the ridges 111 and grooves 112 with a larger amount of semi-rigid material 114 (about 50%) to provide more force to remove stubborn dirt and debris (e.g. gum, food, dried soft drinks, etc.) from the tread surface 406 of the step 401.

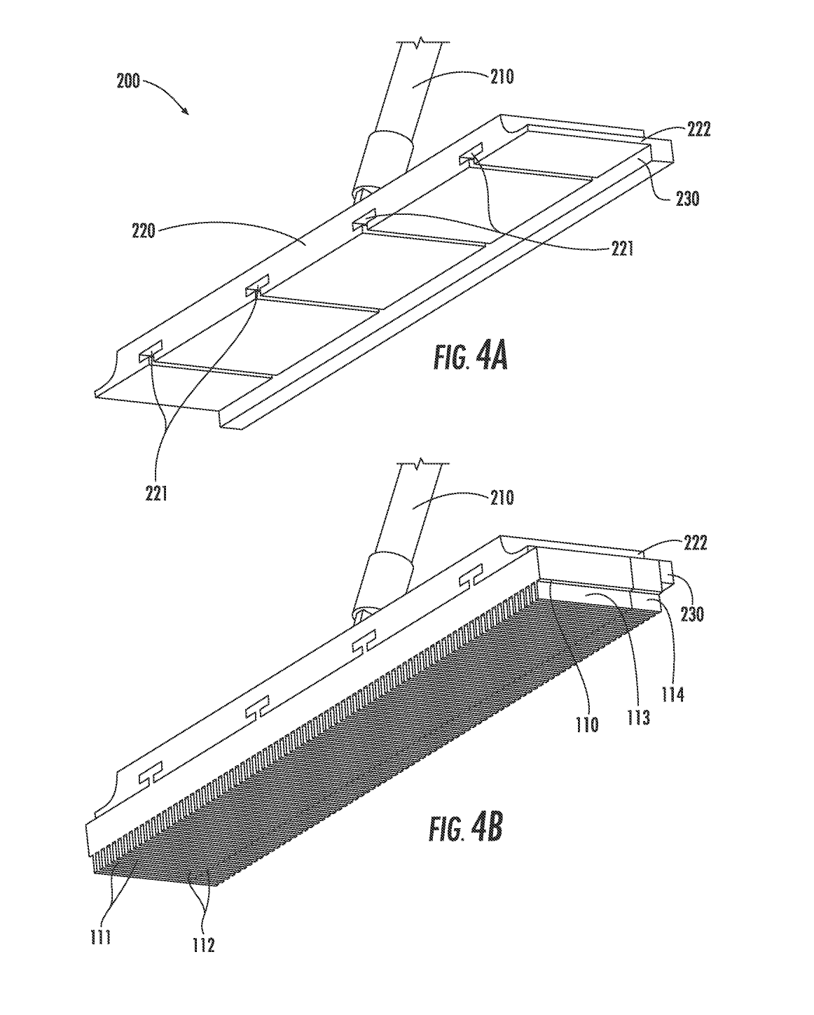

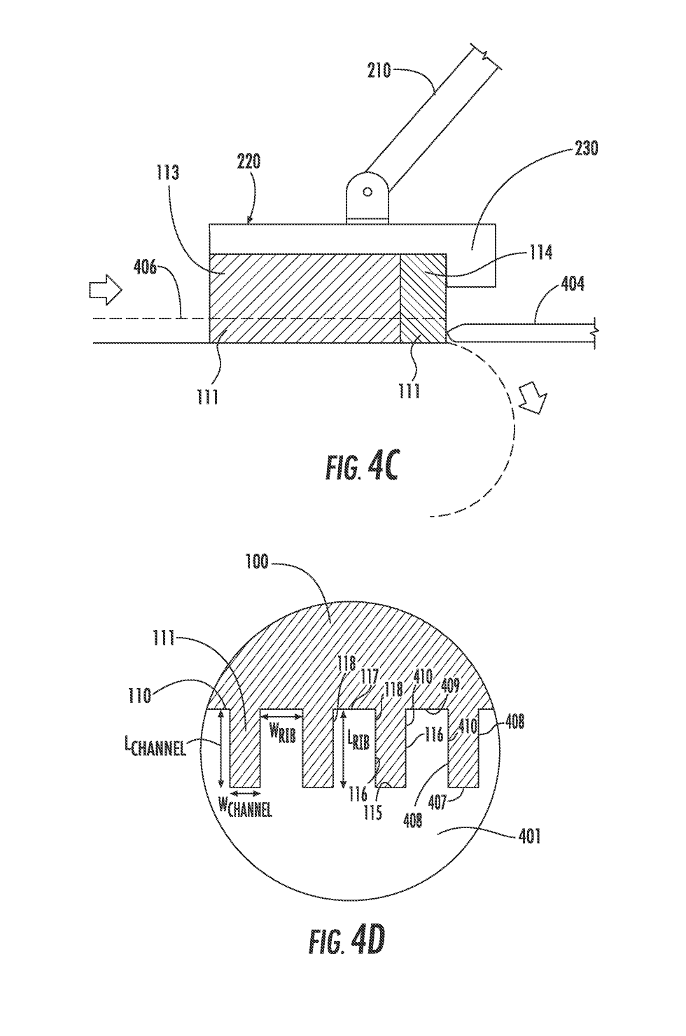

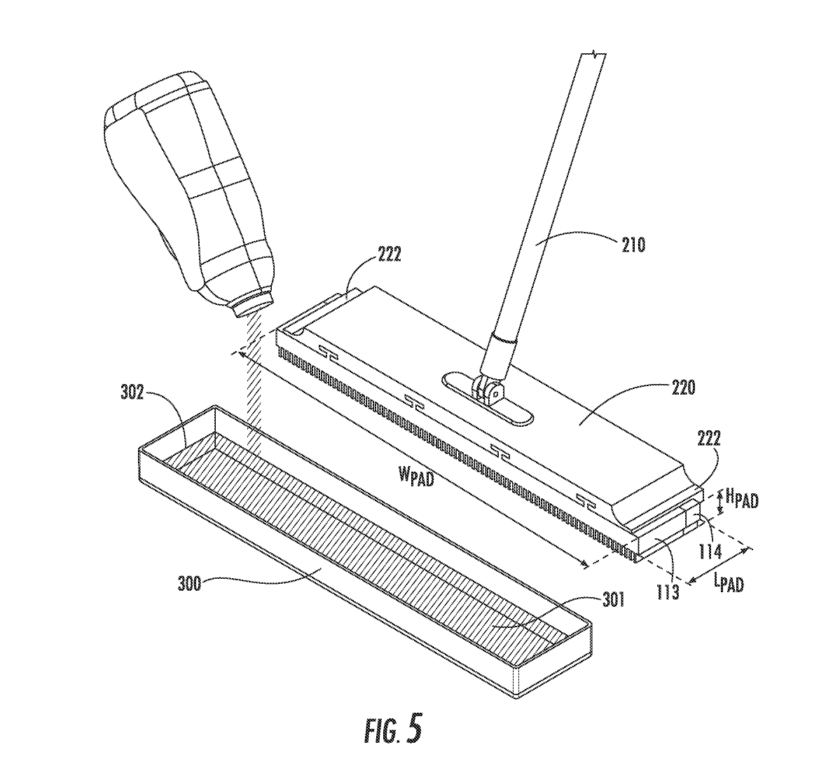

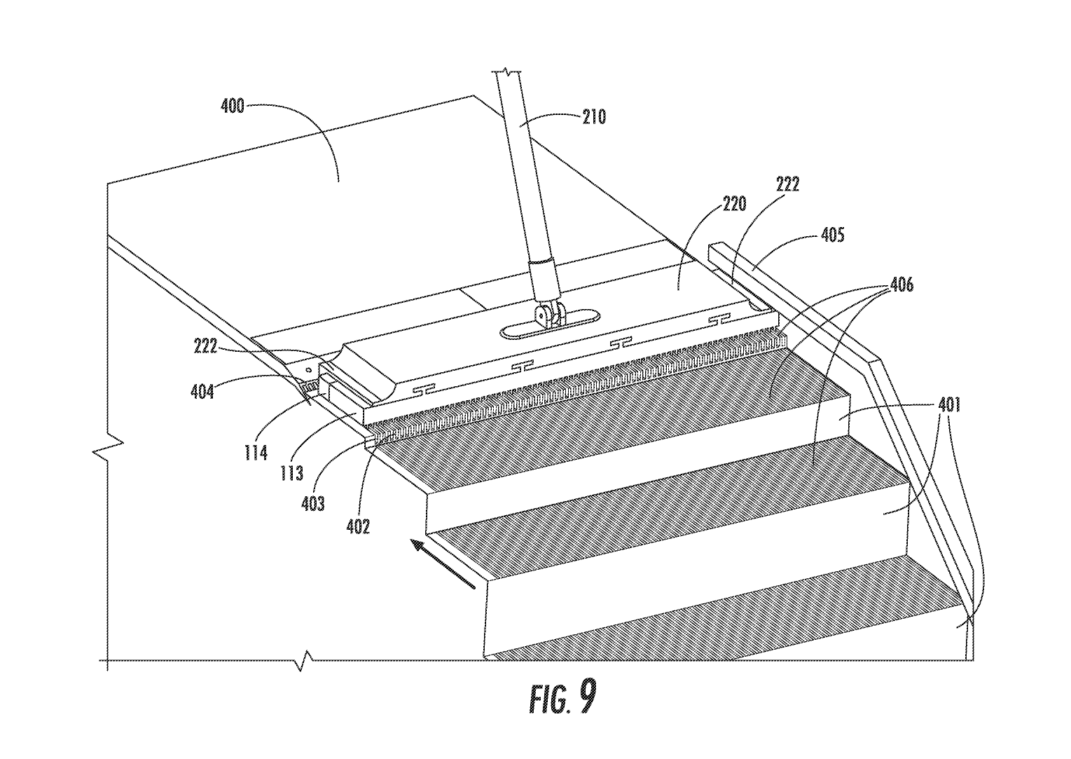

As shown in FIG. 4B and FIG. 8, the ridges 111 are arranged substantially parallel to the grooves 112. To achieve substantially full contact between top 115 and sides 116 of the ridges 111 and the bottom 407 and sides 408 of the channels 403 of the step 401 as well as adequate lateral and downward pressure on the step 401, the ridges 111 preferably have a width W_{ridge} slightly less (at least about 0.02 inches) than the width of the channel W_{channel} and a length L_{ridge} slightly greater (at least about 0.05 inches) than the length of the channel L_{channel}. For example, if the width of the channel W_{channel} is about 0.20 inches and the length of the channel L_{channel} is about 0.50 inches, then the width of the ridge W_{ridge} should be about 0.18 inches and the length of the ridge L_{ridge} should be about 0.55 inches. In an embodiment, the width of the ridges W_{ridge} is about 0.16 to 0.21 inches and the length of the ridges L_{ridge} is about 0.50 to 0.65 inches.

To achieve substantially full contact between the bottom 117 and sides 118 of the grooves 112 and the top 409 and sides 410 of the ribs 402 of the tread surface 406 of the step 401, the grooves 112 preferably have a width W_{groove} slightly greater (at least about 0.02 inches) than the width of the rib W_{rib} and a length L_{groove} slightly greater (at least about 0.05 inches) than the length of the channel L_{rib}. For example, if the width of the ribs W_{rib} is about 0.14 inches and the length of the ribs L_{rib} is 0.50 inches, then the width of the grooves W_{grooves} should be about 0.16 inches and the length of the ridge L_{groove} should be about 0.55 inches. In one embodiment, the width of the grooves W_{groove} is about 0.14 to 0.19 inches and the length of the grooves L_{groove} is about 0.50 to 0.65 inches.

The top 115 and sides 116 of the ridges 111 can also be configured to match the cross-sectional shape of the channels 403 of the step 401, which helps the ridges 111 mate with the channels 403 of the step 401. For example, if the bottom surface 407 of the channels 403 have square or sharp corners, then the top surface 115 of the ridges 111 should also preferably have square or sharp corners. Similarly, if the sides 408 of the channels 403 are tapered, then the sides 116 of the ridges 111 should preferably be tapered in a corresponding manner.

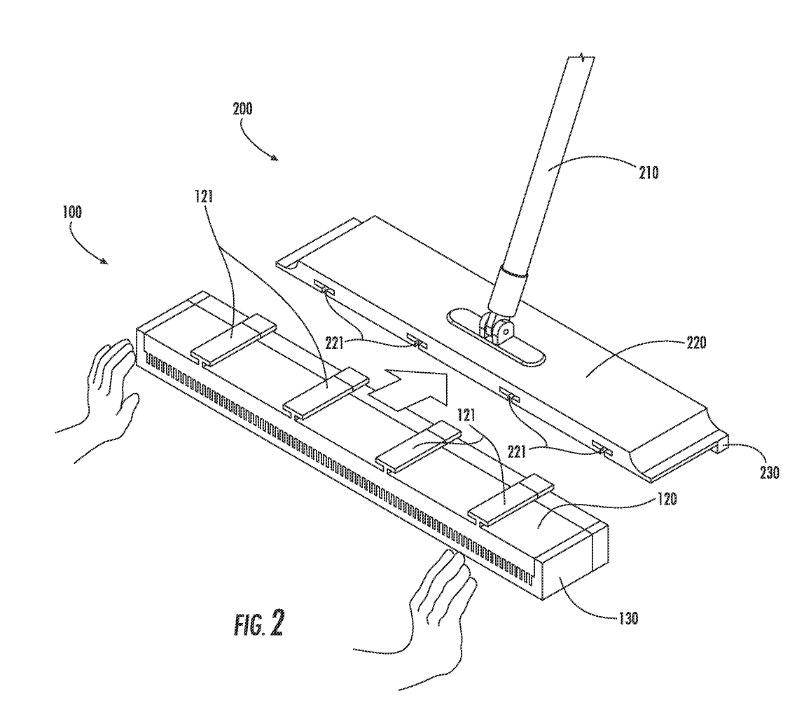

The cleaning pad 100 can further comprise an attachment surface 120 configured to removably and disposably attach the cleaning pad 100 to a cleaning implement 200. The cleaning pad 100 can be attached to the cleaning implement 200 with one or more connections 121. As shown in FIGS. 2-5, in an embodiment, the connections 121 can be one or more protrusions (e.g., T-shaped protrusions) on the attachment surface 120 that are configured to mate with a corresponding set of tracks 221 (e.g., T-shaped tracks) on the cleaning implement 200. Alternatively, the protrusions 121 can be located on the cleaning implement 200 and the tracks 221 can be located on the attachment surface 120. Examples of other suitable connections 121 include, but are not limited to, hooks and loops, clamps, snaps, and so forth.

The cleaning pad 100 can further comprise a cover or sheath 130 for protecting the contact surface 110, particularly the ridges 111 and grooves 112 of the contact surface 110. By providing a cover, the ridges 111 and grooves 112 can be kept substantially straight when the pad is transported. If the ridges 111 and grooves 112 are bent or otherwise damaged, they will not fully mesh with the channels 403 and ribs 402 of the step 401, which can lead to less efficient step cleaning or render the pad inoperable. The cover 130 is preferably sized so that it meshes with and substantially encapsulates the ridges 111 and grooves 112 of the contact surface 110. The ridges of the cover 131 are preferably sized to correspond to the grooves of the cleaning pad 100. Similarly, the grooves of the cover 132 are preferably sized to correspond to the ridges of the cleaning pad 100.

The cleaning pad 100 can be manufactured by processes such as die-cutting, saw cutting, contour cutting, water jet cutting, pin convoluting, molding, extrusion, and so forth. Preferably, as shown in FIG. 11, the cleaning pad 100 is fabricated by die-cutting a block or sheet 700 comprising the absorbent material 113 laminated to the semi-rigid material 114. As discussed above, the semi-rigid material 114 is laminated substantially parallel to the absorbent material 113. During the die cutting process, additional material 113 and 114 can be left on the cleaning pad 100 to provide the cover 130. Leaving the additional material 113 and 114 on the cleaning pad 100 helps keep the ridges 111 and grooves 112 substantially straight while also lessening the concavity that can occur during the die-cutting process.

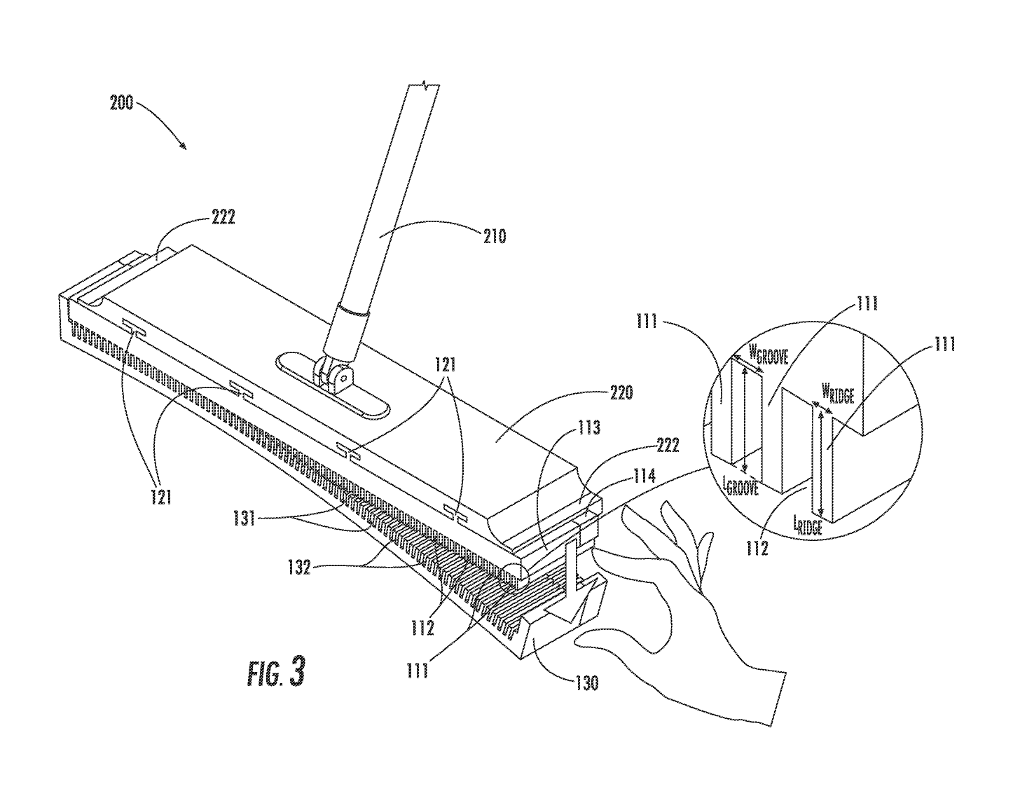

FIG. 2 depicts a cleaning implement 200 for cleaning an escalator or moving walkway according to this invention. The cleaning implement 200 comprises a head portion 220 that is configured to attach to a handle 210. The head portion 220 can be attached to the handle 210 by any conventional manner such as a pivot connection as illustrated in FIG. 3, threaded connection, and so forth. The head portion 220 is configured to removably attach the cleaning implement 200 to the cleaning pad 100. The head portion 220 can be attached to the attachment surface 120 in a variety of manners including corresponding connections 121 and tracks 221 as described above.

In an embodiment, the width of the head portion 220 can be slightly less than the width W_{pad} of the cleaning pad 100 to allow any portions of the cleaning pad 100 that may contact the sides of the escalator or moving walkway 400 to be soft and pliable so they can easily fit between the sides of the escalator or moving walkway 400. The head portion 220 can comprise guides 222 configured to fit underneath the skirt or deflector brush 405 that extends along the sides of the escalator or moving walkway 400 as shown in FIG. 3 and FIG. 9. The guides 222 help maintain the position of the cleaning pad 100 over the escalator or moving walkway 400, permitting the cleaning pad 100 to contact substantially all of the tread surface 406 of the step 401. The width W_{pad} of the cleaning pad 100 extends substantially perpendicular to direction of motion of the step 401 as shown in the Figures. As the escalator or moving walkway step 401 moves toward the cleaning pad 100 during cleaning operations as shown in FIG. 9, the step exerts a lateral force against the cleaning pad 100, which can dislodge the cleaning pad 100 from the cleaning implement 200. As illustrated in FIG. 2 and FIG. 4B, to prevent dislodgement, the head portion 220 can further comprise a stop section 230 configured to maintain the pad 100 in place during cleaning operations.

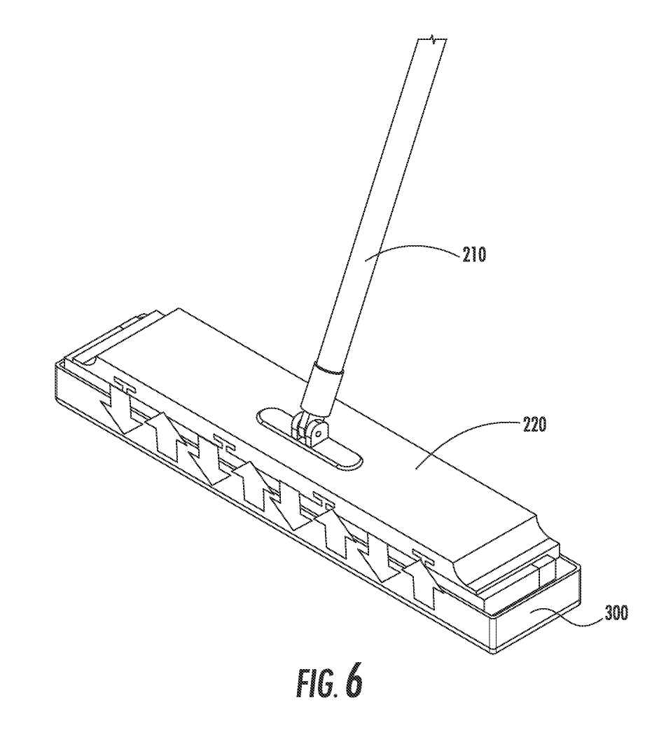

In operation, the cleaning pad 100 is mounted to the cleaning implement 200 using the one or more connections 121. In an embodiment, as shown in FIG. 2, the cleaning pad 100 can be mounted to the cleaning implement 200 by sliding the T-shaped connections 121 located on the attachment surface 120 onto corresponding T-shaped tracks 221 located on the head portion 220 of the cleaning implement 200. The cover 130 is removed from the cleaning pad 100 to expose the ridges 111 and grooves 112 on the contact surface 110 (FIG. 3). The cleaning pad 100, preferably substantially all of the cleaning pad 100, is then placed in a trough 300 with a predetermined amount of cleaning fluid 301 (FIG. 5). The trough 300 can include a fill line 302 for accurately pouring the desirable amount of cleaning fluid 301. The trough 300 can also be configured to releasably connect to the head portion 220 using one or more releasable connectors such as latches, pins and so forth.

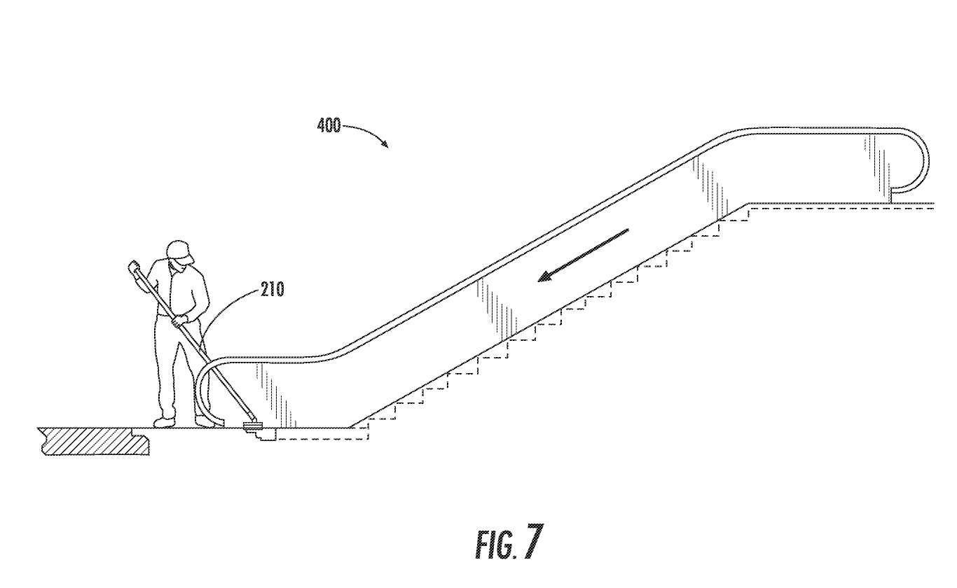

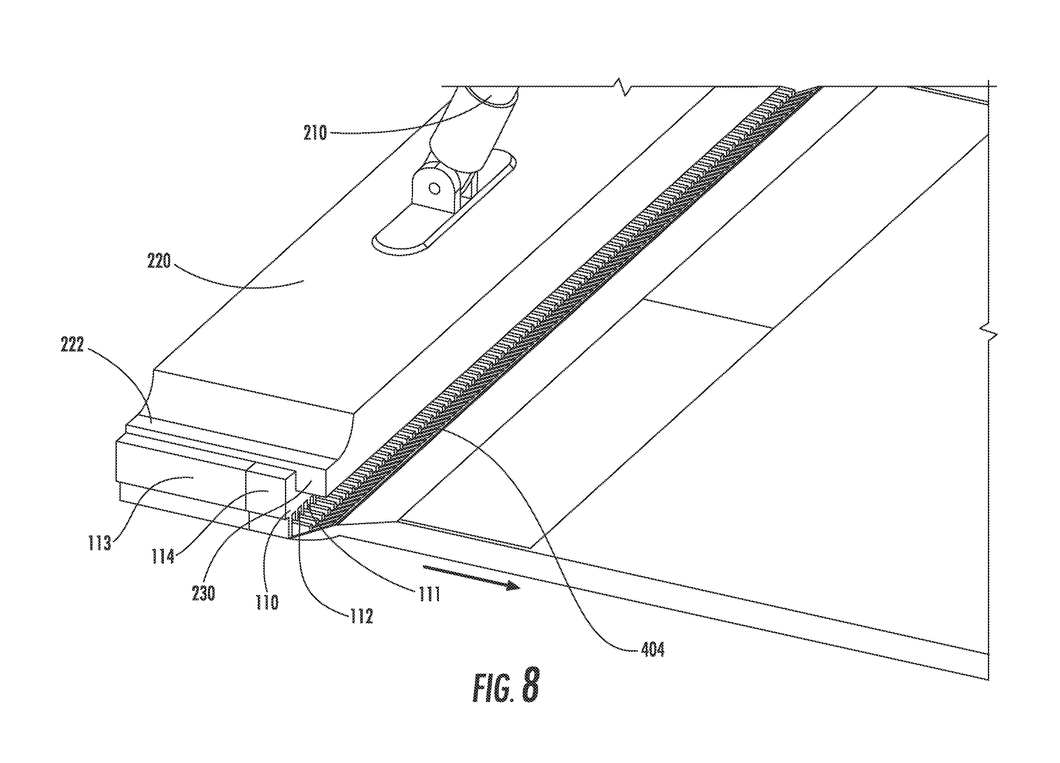

The cleaning implement 200 with attached cleaning pad 100 is then loaded with cleaning fluid 301 by submersing it and compressing it to activate its absorbent properties one or more times in the trough 300 to saturate the contact surface 110 with cleaning fluid 301 (FIG. 6). The contact surface 110 is then placed onto any of the reachable steps moving towards the comb, typically the first two or three steps immediately before the comb 404 of the escalator or moving walkway 400, preferably while the escalator or moving walkway 400 is in operation (FIGS. 7-9).

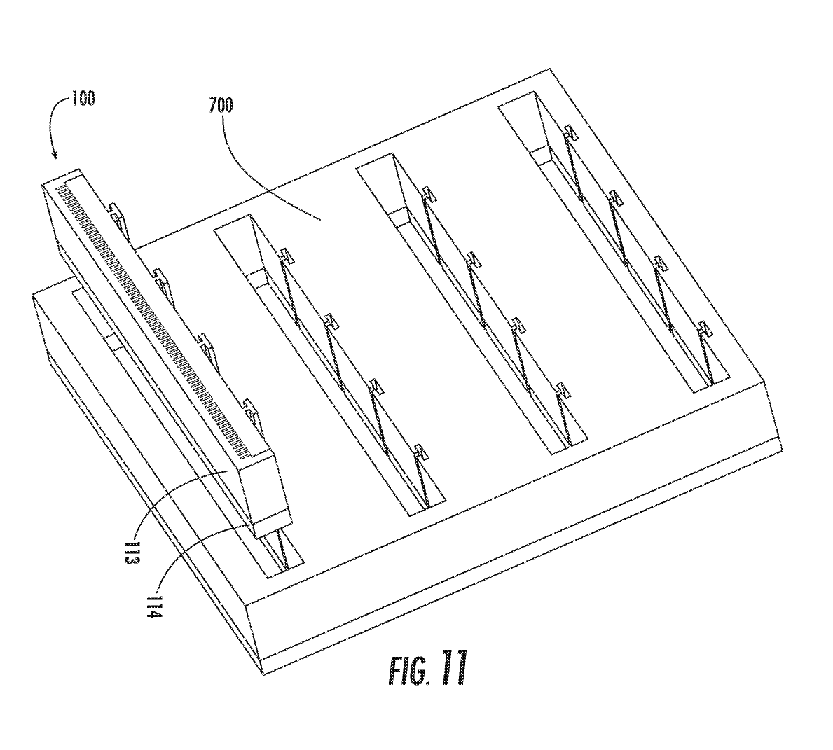

During cleaning operations, the steps 401 are preferably moving towards the cleaning implement 200 (FIGS. 7-9). The cleaning pad 100 is positioned so that the semi-rigid material 114 abuts the comb 404 of the escalator or moving walkway 400 with the ridges 111 and grooves 112 of the cleaning pad 100 aligned and meshed with the channels 403 and ridges 402 of the step 401. With the cleaning pad 100 so placed and positioned, the escalator or moving walkway 400 then runs for a predetermined amount of time. As the escalator or moving walkway 400 runs, the semi-rigid material 114 of the cleaning pad 100, particularly the ridges 111 and grooves 112 of the semi-rigid material 114, act as a squeegee or wiper to remove any excess cleaning fluid while also offering the rigidity required to scrub stains and peel away deposited dirt and stubbornly adhered debris from the top 409 and sides 410 of the ribs 402 and bottom 407 and sides 408 of the channels 403 of the step 401. Similarly, the absorbent material 113 of the cleaning pad 100, particularly the ridges 111 and grooves 112 of the absorbent material 113, scrubs stains and remove dirt and debris from the top 409 and sides 410 of the ribs 402 and the bottom 407 and sides 408 channels 403 of the step 401. After the predetermined amount of time, if the step(s) 401 require additional cleaning, then the process can be repeated. To remove and dispose of the cleaning pad 100 after use, the cleaning pad 100 can be slid off the cleaning implement 200 by using the T-shaped protrusions 121 and tracks 221 and discarded in a trash receptacle 600 (FIG. 10).

The following table lists the descriptions of the reference numbers/characters used in the accompanying drawings:

REFERENCE LIST FOR NUMBERS/CHARACTER IN DRAWINGS

| Number/ | |
|---|---|
| Character | Description |
| 100 | Cleaning pad |
| 110 | Contact surface of cleaning pad 100 |
| 111 | Ridge(s) of contact surface 110 |
| 112 | Groove(s) of contact surface 110 |
| 113 | Absorbent material of cleaning pad 100 |
| 114 | Semi-rigid material of cleaning pad 100 |
| 115 | Top of ridge(s) 111 of contact surface 100 |
| 116 | Side of ridge(s) 111 of contact surface 100 |
| 117 | Bottom of grooves(s) 112 of contact surface 100 |
| 118 | Side of groove(s) 112 of contact surface 100 |
| 120 | Attachment surface of cleaning pad 100 |
| 121 | Connections for attaching cleaning pad 100 to |
| | cleaning implement 200 |
| 130 | Cover or sheath of cleaning pad 100 to protect |
| | contact surface 100 |
| 131 | Ridge(s) of cover 130 |
| 132 | Grooves(s) of cover 130 |
| 200 | Cleaning implement |
| 210 | Handle of cleaning implement 200 |
| 220 | Head portion of cleaning implement 200 |
| 221 | Tracks of cleaning implement 200 |
| 222 | Guides of head portion 220 |
| 230 | Stop section of head portion 220 |
| 300 | Trough for cleaning fluid 301 |
| 301 | Cleaning fluid |
| 400 | Escalator or moving walkway |
| 401 | Step of escalator or moving walkway 400 |
| 402 | Rib(s) of step 401 |
| 403 | Channel(s) of step 401 |
| 404 | Comb of escalator or moving walkway 400 |
| 405 | Skirt or deflector brush of escalator 400 |
| 406 | Tread surface of step 401 of escalator or moving walkway 400 |
| 407 | Bottom of channel(s) 403 of tread surface 406 of step 401 |
| 408 | Side of channel(s) 403 of tread surface 406 of step 401 |
| 409 | Top of ribs(s) 402 of tread surface 406 of step 401 |
| 410 | Side of rib(s) 402 of tread surface 406 of step 401 |
| 600 | Trash receptacle |
| 700 | Block or sheet of absorbent material 113 for die-cutting |
| | cleaning pad 100 and cover 300. |
| W_{pad} | Width of the cleaning pad 100 |
| L_{pad} | Length of the cleaning pad 100 |
| H_{pad} | Height of the cleaning pad 100 |
| W_{groove} | Width of the groove(s) 112 of the contact surface 110 |
| L_{groove} | Length of the groove(s) 112 of the contact surface 110 |
| W_{ridge} | Width of the ridge(s) 111 of the contact surface 110 |
| L_{ridge} | Length of the ridge(s) 111 of the contact surface 110 |
| W_{channel} | Width of the channel(s) 403 of the escalator or |
| | walkway step 401 |
| L_{channel} | Length of the channel(s)403 of the escalator or |
| | walkway step 401 |
| W_{rib} | Length of the rib(s) 402 of the escalator or walkway step 401 |
| L_{rib} | Length of the ribs(s) 402 of the escalator or walkway step 401 |

Any reference to patents, documents and other writings contained herein shall not be construed as an admission as to their status with respect to being or not being prior art. Although the present invention and its advantages have been described in detail, it is understood that the array of features and embodiments taught herein may be combined and rearranged in a large number of additional combinations not directly disclosed, as will be apparent to one having ordinary skill in the art. The invention disclosed herein may be practiced in the absence of any element which is not specifically disclosed herein. It should be understood that various changes, substitutions and alterations can be made herein without departing from the spirit and scope of the invention as defined by the following claims. There are, of course, other embodiments, which are alternatives to the foregoing descriptions of the invention, which are intended to be included within the scope of the invention, as defined by the following claims.

What is claimed is:

1. A cleaning pad for an escalator or moving walkway, the cleaning pad comprising:
a. a contact surface with a plurality of ridges and grooves configured to mesh with the channels and ribs of an escalator or moving walkway step.

2. The cleaning pad of claim 1 further comprising an absorbent material.

3. The cleaning pad of claim 2 further comprising a semi-rigid material.

4. The cleaning pad of claim 3, wherein the semi-rigid material is positioned substantially parallel to the absorbent material so that that the ridges and grooves of the semi-rigid material are coincident with those of the absorbent material.

5. The cleaning pad of claim 4, wherein the absorbent material has a pore size between about 20 to 150 pores per inch.

6. The cleaning pad of claim 5, wherein the absorbent material has a density of about 0.8 to 5.0 pounds per cubic foot.

7. The cleaning pad of claim 6, wherein the absorbent material has an air flow of about 1.0 to 10.0 SCFM.

8. The cleaning pad of claim 7, wherein the absorbent material has an indentation force deflection of about 15 to 150 IFD.

9. The cleaning pad of claim 8, wherein the semi-rigid material is polyethylene.

10. The cleaning pad of claim 7 further comprising a protective cover removably attachable to the contact surface and configured to keep the ridges and grooves substantially straight.

11. The cleaning pad of claim 3, wherein the ridges have a length of about 0.50 to 0.65 inches.

12. The cleaning pad of claim 11, wherein the ridges have a width of about 0.16 to 0.21 inches.

13. The cleaning pad of claim 12, wherein the grooves have a width of about 0.14 to 0.19 inches.

14. The cleaning pad of claim 13, wherein the pad is produced by die cutting.

15. The cleaning pad of claim 4, wherein the ridges and grooves are constructed from about 10% to 25% semi-rigid material.

16. A device for cleaning an escalator or moving walkway, the device comprising:
a. a cleaning implement comprising:
i. a head portion configured to attach to a handle; and
b. cleaning pad removably attached to the head portion, the cleaning pad comprising:
i. a contact surface with a plurality of ridges and grooves constructed from an absorbent material and a semi-rigid material, wherein the semi-rigid material is arranged substantially parallel to absorbent material so that that the ridges and grooves of the semi-rigid material are coincident with those of the absorbent material.

17. The device of claim 16, wherein the ridges have a length of about 0.50 to 0.65 inches, and a width of about 0.16 to 0.21 inches.

18. The device of claim 17, wherein the cleaning pad further comprises an absorbent material having a pore size between about 20 to 150 pores per inch.

19. The device of claim 18, wherein the absorbent has a density of about 0.8 to 5.0 pounds per cubic foot.

20. A method for cleaning an escalator or moving walkway having a comb, the method comprising:
a. mounting a cleaning pad to a cleaning implement, wherein the cleaning pad comprises:
i. a contact surface with a plurality of ridges and grooves arranged substantially parallel to each other, the contact surface comprising an absorbent material;
b. loading the contact surface with cleaning fluid;
c. placing the contact surface on a step of the escalator or moving walkway, adjacent to the comb, when the escalator or moving walkway is in operation;
d. aligning and meshing the ridges and grooves of the cleaning pad with the step.

21. The method of claim 20 wherein the ridges and grooves of the cleaning pad align and mesh with channels and ribs of the step.
